(19) United States
(12) Patent Application Publication
(10) Pub. No.: US 2009/0212610 A1
(43) Pub. Date: Aug. 27, 2009

(54) Vehicle seat

(75) Inventor: Kiyoshi Yajima, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/380,173

(22) Filed: Feb. 24, 2009

(30) Foreign Application Priority Data
Feb. 25, 2008 (JP) P2008-043332

(51) Int. Cl. B60N 2/44

(52) U.S. Cl. 297/217.1

(57) ABSTRACT

A vehicle seat wherein an area for storing articles is provided on a rear seat is disclosed. The area for storing small articles is provided in a side bolster disposed on the side surface of a seatback located toward a vehicle body wall. The side bolster includes a base member formed in a curved shape in cross section so as to have a space facing toward the vehicle body wall. An opening is formed in a longitudinal direction in an outer layer member for covering a front surface of the base member. The opening is contiguous with the space. Small articles can be deposited and withdrawn from inside the space through the opening.

### FIELD OF THE INVENTION

The present invention relates to a vehicle seat provided with a storage area for articles.

### BACKGROUND OF THE INVENTION

Rear seats having a seatback and a seat cushion are used in vehicles. In such vehicle seats, the seatback sometimes includes a stowable armrest, and a hatch for providing trunk access (trunk-through arrangement) is often provided at the back of the stowable armrest.

A vehicle seat provided with a storage area for small articles in the seatback is disclosed in JP 2000-333780 A. The disclosed seatback has a recess that opens on the front surface of the seat (inside the passenger compartment). The recess can be opened and closed by rotating a backrest on a hinge. A storage area for small articles is located at the back of the backrest. The storage area for small articles has a pocket for storing small articles.

In the above-mentioned vehicle seat, however, the storage area for small articles is located in the backrest; the backrest cannot be opened or closed when a vehicle occupant is seated, and small articles cannot be taken out, rendering the storage area for small articles difficult to use.

Furthermore, in the above-mentioned seat, the backrest having the storage area for small objects is installed so as to be openable and closeable about a hinge installed vertically in the vehicle body, necessitating a large space for opening and closing the storage area for small articles and causing discomfort to vehicle occupants.

### SUMMARY OF THE INVENTION

It is therefore an object of the present invention to provide a vehicle seat having a storage space that vehicle occupants can use even when seated and that can accommodate small articles without causing discomfort to the vehicle occupants.

According to an aspect of the present invention, there is provided a vehicle seat which comprises: a seat body having a seat cushion for seating a vehicle occupant and a seatback for supporting the back of the vehicle occupant; and side bolsters adapted to be interposed between a side surface of the seat body and a side surface of a vehicle body wall, wherein each of the side bolsters includes a base member formed in such a shape in cross section as to form a space inside or to form a space between the base member and the vehicle body wall, and an outer layer member for covering a front surface of the base member, the base member has a hole formed to communicate with the space, and the outer layer member has an opening formed to communicate with the hole.

With this arrangement, small articles (stored goods) can be inserted into the space inside the base member through the opening in the outer layer member via the hole. The opening in the outer layer member can thereby be used even when the vehicle occupant is seated, and small articles can be stored easily. In addition, because the side bolsters are provided between the side surfaces of the seat body and the vehicle body walls, storage space can be created without bringing discomfort to the vehicle occupants.

It is preferred that a storage bag communicating with the opening be provided to the outer layer member, and that the storage bag be placed in the space of the base member. Small articles can thus be placed in the storage bag through the opening.

The outer layer member comprises a seat-facing outer layer disposed toward a side surface of the seat body, and a sidewall-facing outer layer sewn to the seat-facing outer layer and disposed toward the side wall of the vehicle body. The opening is formed in an area in which the seat-facing outer layer and the sidewall-facing outer layer are sewn together. Accordingly, the opening can be made inconspicuous, and a visually attractive storage area for small articles can be formed.

It is preferred that the opening be provided with a fastener for opening and closing the opening. In particular, the use of a hidden slide fastener is preferred from the standpoint of appearance.

The opening preferably takes the form of a slit. Frequently depositing and withdrawing small articles is therefore made more convenient.

It is preferred that the opening be covered by a cover so as to be openable and closable, and the cover be detachable from the outer layer member by at least one fastening device. Opening/closing operation of the cover is thus facilitated.

### BRIEF DESCRIPTION OF THE DRAWINGS

Certain preferred embodiments of the present invention will be described in detail below, by way of example only, with reference to the accompanying drawings, in which:

FIG. 1 is a perspective view of a passenger compartment in which a vehicle seat according to a first embodiment of the present invention is employed;

FIG. 2 is an enlarged sectional view taken along line 2-2 of FIG. 1;

FIG. 3 is an enlarged sectional view taken along line 3-3 of FIG. 1;

FIG. 4 is an exploded perspective view of a side bolster of FIG. 2;

FIGS. 5A through 5D are views showing operations in which small articles are placed inside one of the side bolsters;

FIGS. 6(a) through (e) illustrate examples of small articles that can be stored in the side bolsters;

FIG. 7 is a perspective view of a vehicle seat according to a second embodiment of the present invention, showing an example opening formed as a slit; and

FIGS. 8A and 8B are perspective views of a vehicle seat according to a third embodiment of the present invention, showing an example in which a cover is placed over the opening.

### DETAILED DESCRIPTION OF THE PREFERRED EMBODIMENTS

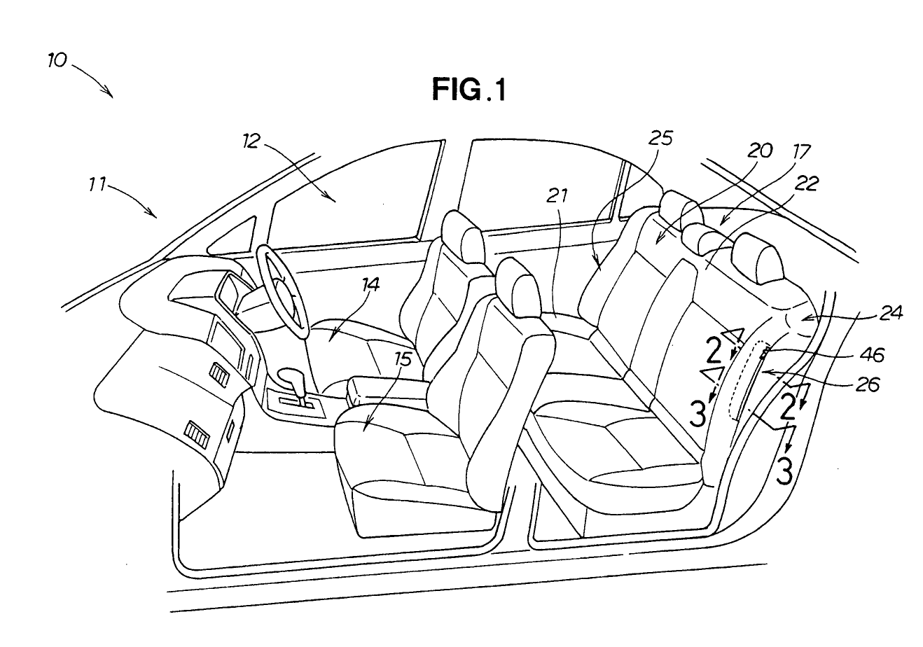

As shown in FIG. 1, a vehicle 10 has a passenger compartment 12 in a substantial center of a car body 11.

The passenger compartment 12 is provided with a driver's seat 14, a passenger seat 15, and a rear seat (seat body) 17 behind the driver's seat 14 and the passenger seat 15.

The rear seat 17 is composed of a seat cushion 21 and a seatback 22.

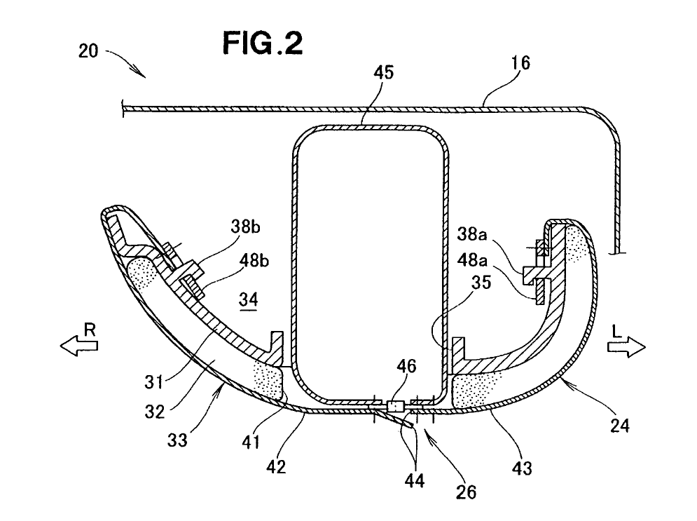

Left and right side bolsters 24 and 25, which fill up a space between the seatback 22 and a side surface of a vehicle body wall 16 (see FIG. 2), are installed on either side surface of the seatback 22.

A vehicle seat 20 according to a first embodiment is composed of the rear seat 17 and the left and right side bolsters 24 and 25.

In FIGS. 2 through 4, arrow L indicates the left side of the vehicle 10 (FIG. 1), and arrow R indicates the right side of the vehicle.

The side bolster 24 comprises a base member 31 supported by the vehicle body wall 16, a cushion member 32 mounted on the base member 31, and an outer layer member 33 for covering the base member 31 and cushion member 32.

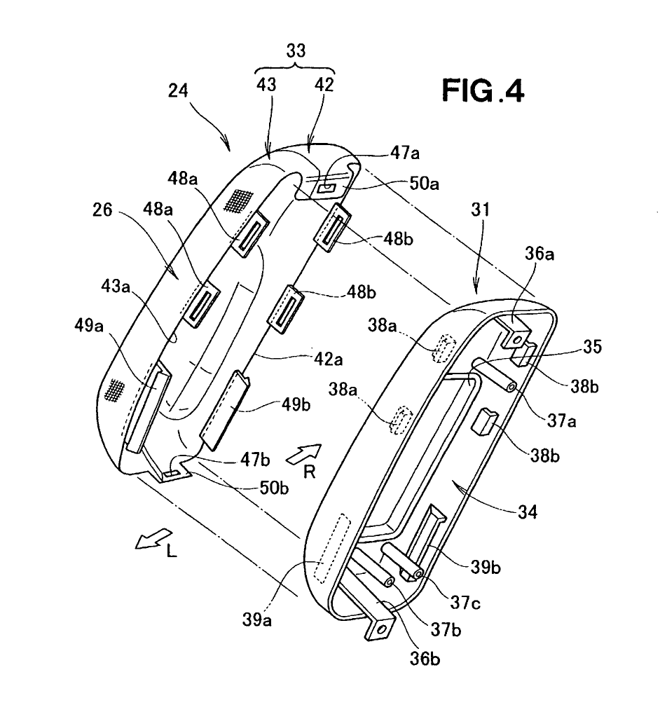

The base member 31 is formed from resin in a curved shape in cross section and has a space 34. The space 34, as shown in FIGS. 2 and 4, opens toward the vehicle body wall 16.

The base member 31, as shown in FIG. 4, includes a hole 35 formed in a substantial center in the widthwise direction; an upper mount 36a locked into a top part of the outer layer member 33 and mounted on the vehicle body wall 16; a lower mount 36b locked into a bottom part of the outer layer member 33 and mounted on the vehicle body wall 16; two first left plugs 38a, 38a arranged above and below for locking into an upper half of the outer layer member 33; two first right plugs 38 b, 38 b arranged above and below for locking into the upper half of the outer layer member 33; a first left socket 39a for locking into a lower half of the outer layer member 33; a first right socket 39b for locking into the lower half of the outer layer member 33; and first through third bosses 37a through 37c in contact with the vehicle body wall 16.

The cushion member 32 is a member formed along the contour of the base member 31 and includes a escape hole 41 formed alongside the hole 35.

The outer layer member 33 comprises a seat-facing outer layer 42 disposed toward the seatback 22; a sidewall-facing outer layer 43 sewn to the seat-facing outer layer 42 and disposed toward the vehicle body wall 16; an opening 44 provided between the seat-facing outer layer 42 and the sidewall-facing outer layer 43 and formed so as to face the hole 35 of the base member 31; a storage bag 45 for storing small articles that is located so as to be contiguous with the opening 44; a fastener 46 provided to the opening 44 and used for opening and closing the opening 44; an upper extension 50a extended across the top parts of the seat-facing outer layer 42 and sidewall-facing outer layer 43; an upper locking hole 47a formed in the upper extension 50a and locked with the upper mount 36a; a lower extension 50b extended across the bottom parts of the seat-facing outer layer 42 and the sidewall-facing outer layer 43; a lower locking hole 47b formed in the lower extension 50b and locked with the lower mount 36b; second left sockets 48a, 48a provided at the top and center of a side edge 43a of the sidewall-facing outer layer 43 and locked with the first left plugs 38a, 38a; a second left plug 49a provided at the bottom of the side edge 43a of the sidewall-facing outer layer 43 and locked with the first left socket 39a; second right sockets 48b, 48b provided in a side edge 42a of the seat-facing outer layer 42 and locked with the first right plugs 38b, 38b; and a second right plug 49b provided at the bottom of the side edge 42a of the seat-facing outer layer 42 and locked with the first right socket 39b.

The seat-facing outer layer 42 and sidewall-facing outer layer 43 are formed from fabric.

The opening 44 has a slit shape.

The storage bag 45 is formed from fabric and is sewn to the seat-facing outer layer 42 and sidewall-facing outer layer 43. The storage bag 45 is preferably waterproofed.

The use of a hidden slide fastener for the fastener 46 conceals the slider and the rows of meshing elements from the outside and is preferred from the standpoint of appearance.

The second left sockets 48a, 48a and the second left plug 49a are sewn to the sidewall-facing outer layer 43. The second right sockets 48b, 48b and the second right plug 49b are sewn to the seat-facing outer layer 42. The second left and right sockets 48a, 48a, 48b, 48b have the same shape. The second left plug 49a and the second right plug 49b have the same shape.

The fastener 46 is provided to the slit 44 and is sewn to the seat-facing outer layer 42 and the sidewall-facing outer layer 43.

A small-article storage area 26 is composed of the seat-facing outer layer 42, the sidewall-facing outer layer 43, the opening 44, the storage bag 45, and the fastener 46.

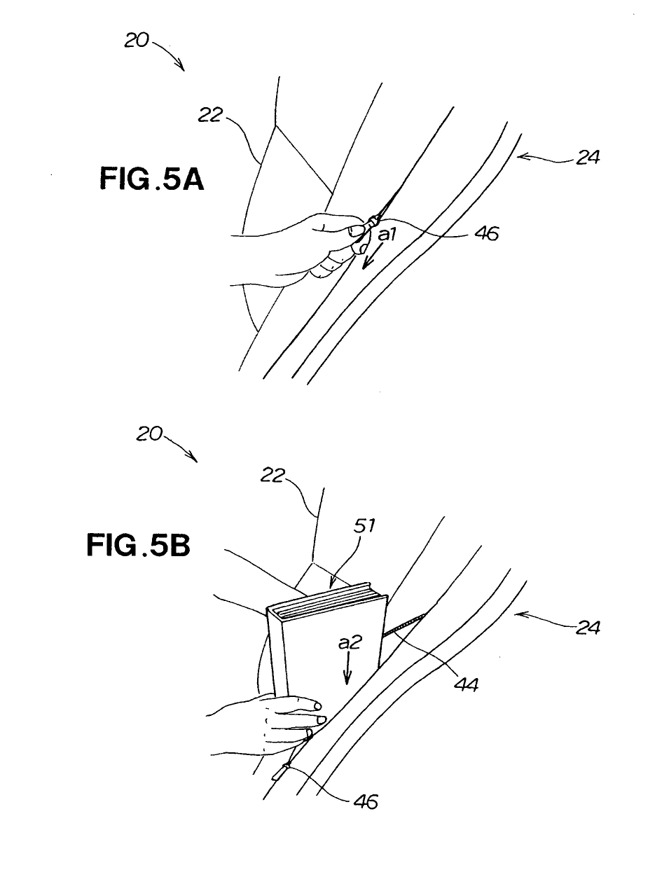

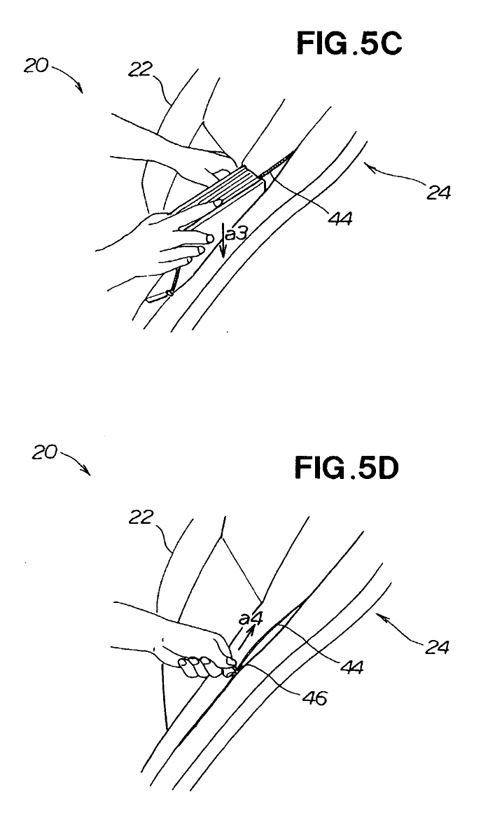

Next, a method for placing small articles in a side bolster will be described based on FIGS. 5A through 5D.

In FIG. 5A, the fastener 46 is pulled open as indicated by arrow a1.

In FIG. 5B, a storage item (e.g., a service manual) 51 is inserted into the opened opening 44 as indicated by arrow a2.

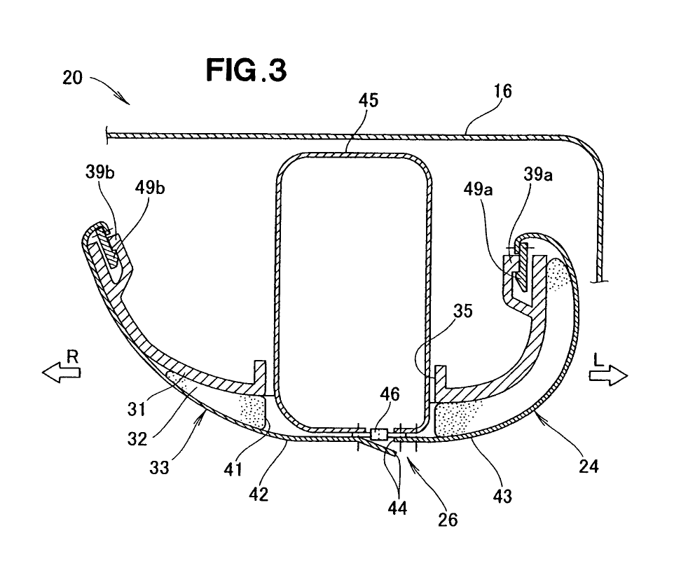

In FIG. 5C, the storage item 51 is pushed inside the storage bag 45 (FIG. 3) through the opening 44, as indicated by arrow a3.

In FIG. 5D, the fastener 46 is closed as indicated by arrow a4, completing the storage of the storage item 51.

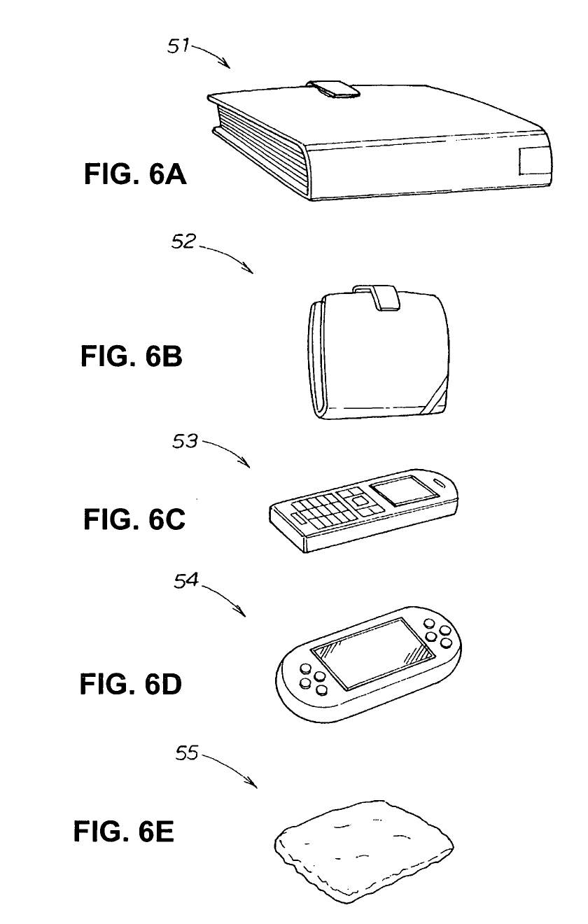

FIGS. 6(a) through 6(e) show examples of storage items that can be stored inside the side bolsters shown in FIG. 1.

The storage item shown in FIG. 6(a) is a service manual 51 for the vehicle 10 (FIG. 1). A vehicle occupant seated in the rear seat 17 can promptly look up items of interest as needed, even while the vehicle 10 is moving.

FIG. 6(b) shows a wallet 52 as a storage item. For example, the driver can immediately access small change when exiting a parking lot, and will not forget where the wallet is placed when paying or performing other transactions at a drive-through.

FIG. 6(c) shows a vehicle remote control 53 as a storage item. The vehicle remote control can be kept within easy reach of a vehicle occupant seated in the rear seat 17.

FIG. 6(d) shows a game console 54 as a storage item. A vehicle occupant seated in the rear seat 17 can enjoy a game during a traffic backup or in other such situations.

FIG. 6(e) shows a towel 55 as a storage item. Vehicle occupants with children can also store supplies for the care of children, such as disposable diapers.

When the storage bag 45 (FIG. 2) is made so as to be waterproof, a collapsible umbrella, for example, or other wet articles can also be stored.

The outer layer member 33 has the opening 44 that is contiguous with the storage bag 45, and a vehicle occupant can therefore use the opening 44 of the outer layer member 33 even when seated. Since the side bolsters are provided at the vehicle body wall 16, a small-article storage area (storage space) can be formed without bringing discomfort to vehicle occupants.

In the vehicle seat 20, because the outer layer member 33 is provided with the storage bag 45 contiguous with the opening 44, and the storage bag 45 is placed in a concave area of the base member 31, small articles can be placed in the storage bag 45 through the opening 44.

In the vehicle seat 20, the outer layer member 33 is composed of the seat-facing outer layer 42 located on the side of the seatback 22, and the sidewall-facing outer layer 43 sewn to the seat-facing outer layer 42 and located on the side opposite from the seatback 22.

Since the opening 44 is located in an area in which the seat-facing outer layer 42 and the sidewall-facing outer layer 43 are sewn together, the opening 44 can be made inconspicuous, and the small-article storage area 26 can be formed so as to be visually attractive.

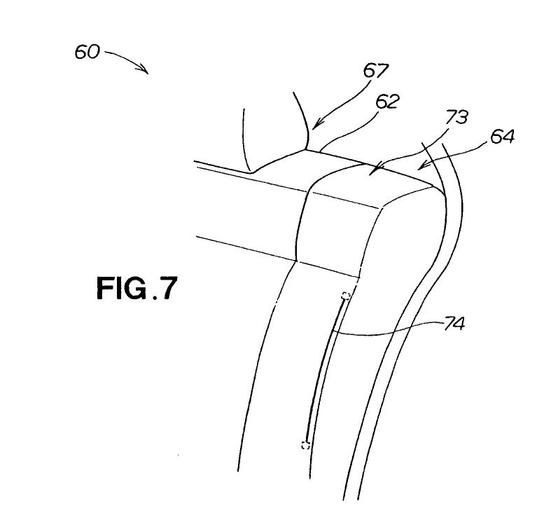

FIG. 7 shows a vehicle seat 60 according to a second embodiment.

The vehicle seat 60 is composed of a rear seat 67 having the seat cushion 21 (FIG. 1), and a seatback 62, as well as a left side bolster 64 and the right side bolster 25 (FIG. 1).

The side bolster 64 is disposed on one side of the seatback 62 and is interposed between the seatback 62 and the vehicle body wall 16 (FIG. 2).

The side bolster 64 has substantially the same configuration as the side bolster 24 according to the first embodiment shown in FIG. 2 and comprises the base member 31 (FIG. 2) and an outer layer member 73.

In the side bolster 64 according to the second embodiment, an opening 74 formed in the outer layer member 73 is simply formed in a slit shape. The slit-shaped opening 74 is not fitted with the fastener (fastening device) shown in the first embodiment. This makes it more convenient to frequently deposit and withdraw the storage items 51 through 55 (see FIGS. 7(a) through 7(e)).

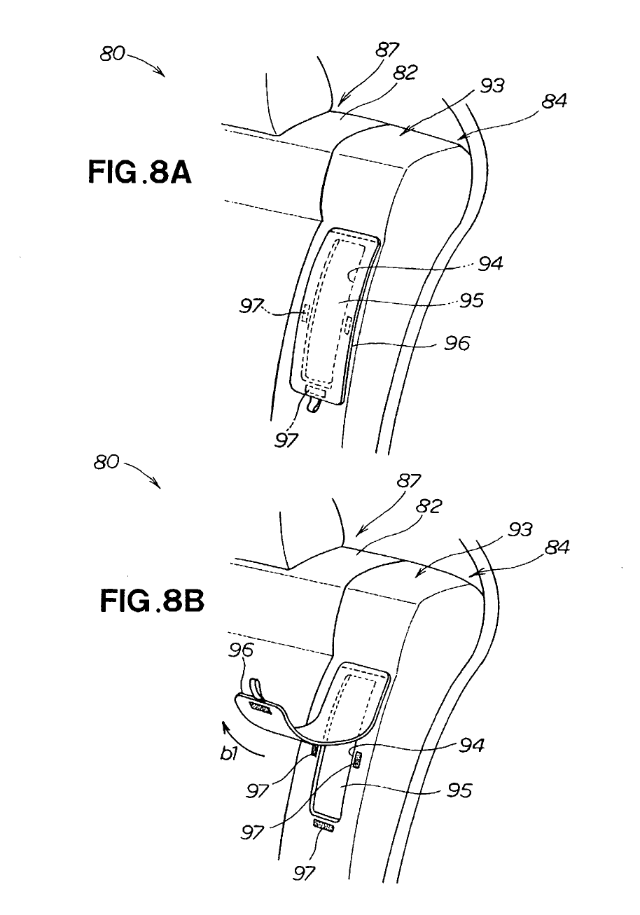

FIGS. 8A and 8B show a vehicle seat 80 according to a third embodiment.

The vehicle seat 80 is composed of a rear seat 87 having the seat cushion 21 (FIG. 1) and a seatback 82, as well as a left side bolster 84 and the right side bolster 25 (FIG. 1).

The side bolster 84 is disposed on one side of the seatback 82 and is interposed between the seatback 82 and the vehicle body wall 16 (FIG. 2).

The side bolster 84 according to the third embodiment has substantially the same configuration as the side bolster 24 according to the first embodiment shown in FIG. 2 and comprises the base member 31 (FIG. 2) and an outer layer member 93.

In the side bolster 84 according to the third embodiment, an opening 94 formed in the outer layer member 93 is covered by a cover 96. The cover 96 is detachably affixed to the outer layer member 93 by a plurality of hook and loop fasteners (fastening devices) 97.

As shown in FIG. 8B, when the cover 96 is lifted up as indicated by arrow b1, the storage items 51 through 55 (see FIGS. 6(a) through 6(e)) can be placed easily in a storage bag 95 through the opening 94.

The first embodiment shows an example in which the opening 44 is formed so as to open and close via the fastener 46, the second embodiment shows an example in which the opening 74 is formed in a slit shape, and the third embodiment shows an example in which the opening 94 is made so as to be covered by the cover 96. However, these examples do not preclude other combinations, as deemed appropriate.

As shown in FIG. 1, the rear seat 17 is shown as an example of a vehicle seat, but this example is nonlimiting, and any vehicle seat having an area provided with a side bolster may be used.

Furthermore, in the present embodiments, examples are shown in which the side bolster 24 is located on a side surface of the seatback 22, but arrangements in which a side bolster is provided to a side surface of the seat cushion are also possible.

Obviously, various minor changes and modifications of the present invention are possible in light of the above teaching. It is therefore to be understood that within the scope of the appended claims the invention may be practiced otherwise than as specifically described.

What is claimed is:

1. A vehicle seat comprising:
a seat body having a seat cushion for seating a vehicle occupant and a seatback for supporting the back of the vehicle occupant; and
side bolsters adapted to be interposed between a side surface of the seat body and a side surface of a vehicle body wall,
wherein each of the side bolsters includes a base member formed in such a shape in cross section as to form a space inside or to form a space between the base member and the vehicle body wall, and an outer layer member for covering a front surface of the base member, the base member has a hole formed to communicate with the space, and the outer layer member has an opening formed to communicate with the hole.

2. The vehicle seat as of claim 1, wherein the outer layer member includes a storage bag communicating with the opening, the storage bag being placed in the space of the base member.

3. The vehicle seat of claim 1, wherein the outer layer member comprises a seat-facing outer layer disposed toward a side surface of the seat body, and a sidewall-facing outer layer sewn to the seat-facing outer layer and disposed toward the side wall of the vehicle body, and the opening is formed in an area in which the seat-facing outer layer and the sidewall-facing outer layer are sewn together.

4. The seat as set forth in claim 1, wherein the opening has a fastening device for opening and closing the opening.

5. The seat as set forth in claim 1, wherein the opening takes the form of a slit.

6. The seat as set forth in claim 1, wherein the opening is covered by a cover so as to be openable and closable, and the cover is detachable from the outer layer member by at least one fastening device.
